(19) United States
(12) Patent Application Publication
(10) Pub. No.: US 2024/0155512 A1
(43) Pub. Date: May 9, 2024

(54) PHR PROCEDURE FOR SDT

(71) Applicant: Nokia Technologies Oy, Espoo (FI)

(72) Inventors: Samuli Heikki TURTINEN, Oulu (FI); Jussi-Pekka KOSKINEN, Oulu (FI); Chunli WU, Beijing (CN); Daniela LASELVA, Aalborg (DK)

(21) Appl. No.: 18/559,508

(22) PCT Filed: May 8, 2021
(86) PCT No.: PCT/CN2021/092478

§ 371 Date: Nov. 7, 2023

(51) Int. Cl. H04W 52/36; H04W 28/02

(52) U.S. Cl. CPC H04W 52/365; H04W 28/0278

(57) ABSTRACT

An apparatus including: at least one processor; and at least one non-transitory memory including computer program code, the at least one memory and the computer program code configured to, with the at least one processor, cause the apparatus to: determine initiation for an uplink small data transmission for the apparatus; trigger a report, where the report is triggered by the determined initiation for the small data transmission; determine at least one predetermined condition; based upon the at least one predetermined condition, determine to cancel the report triggered by the initiation for the small data transmission; and transmit or cause transmitting of the uplink small data transmission.

### BACKGROUND

### Technical Field

The example and non-limiting embodiments relate generally to communications and, more particularly, to a report sent with a transmission.

### BRIEF DESCRIPTION OF PRIOR DEVELOPMENTS

In 3GPP it is known to use small data transmissions. Reports, such as a power headroom report and a buffer status report are also known to be transmitted with a small data transmission.

### SUMMARY

The following summary is merely intended to be an example. The summary is not intended to limit the scope of the claims.

In accordance with one aspect, an example apparatus is provided comprising: at least one processor; and at least one non-transitory memory including computer program code, the at least one memory and the computer program code configured to, with the at least one processor, cause the apparatus to: determine initiation for an uplink small data transmission for the apparatus; trigger a report, where the report is triggered by the determined initiation for the small data transmission; determine at least one predetermined condition; based upon the at least one predetermined condition, determine to cancel the report triggered by the initiation for the small data transmission; and transmit the uplink small data transmission.

In accordance with another aspect, an example method is provided comprising: determining initiation for an uplink small data transmission for the apparatus; triggering a report, where the report is triggered by the determined initiation for the small data transmission; determining at least one predetermined condition; based upon the determined at least one predetermined condition, determining to cancel the report triggered by the initiation for the small data transmission; and transmitting the uplink small data transmission.

In accordance with another aspect, an example apparatus is provided comprising: at least one processor; and at least one non-transitory memory including computer program code, the at least one memory and the computer program code configured to, with the at least one processor, cause the apparatus to: determine information of at least one predetermined condition to cause a user equipment, after an uplink small data transmission has been determined to be initiated, to perform at least one of: cancel a report triggered by the initiation for the small data transmission, or prevent triggering of the report to accompany the small data transmission; and transmit the information to the user equipment.

In accordance with another aspect, an example apparatus is provided comprising: at least one processor; and at least one non-transitory memory including computer program code, the at least one memory and the computer program code configured to, with the at least one processor, cause the apparatus to: determine initiation for an uplink small data transmission for the apparatus; determine at least one predetermined condition; based upon the at least one predetermined condition and the determined initiation for the small data transmission, determine to have a report triggered; and transmit the uplink small data transmission.

In accordance with another aspect, an example method is provided comprising: determining initiation for an uplink small data transmission for the apparatus; determining at least one predetermined condition; based upon the at least one predetermined condition and the determined initiation for the small data transmission, determining to have a report triggered; and transmitting the uplink small data transmission.

In accordance with another aspect, an example apparatus is provided comprising: at least one processor; and at least one non-transitory memory including computer program code, the at least one memory and the computer program code configured to, with the at least one processor, cause the apparatus to: determine initiation for an uplink small data transmission for the apparatus; determine at least one predetermined condition; based upon the at least one predetermined condition, determine whether to transmit a report with the uplink small data transmission, where the report is configured to be at least partially triggered by the determined initiation for the small data transmission; and transmit the uplink small data transmission.

In accordance with another aspect, an example method is provided comprising: determining initiation for an uplink small data transmission for the apparatus; determining at least one predetermined condition; based upon the at least one predetermined condition, determining whether to transmit a report with the uplink small data transmission, where the report is configured to be at least partially triggered by the determined initiation for the small data transmission; and transmitting the uplink small data transmission.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which features as described herein may be practiced;

FIG. 2 is a diagram illustrating one example method comprising features as described herein;

FIG. 3 is a diagram illustrating one example method comprising features as described herein;

FIG. 4 is a diagram illustrating one example method comprising features as described herein;

FIG. 5 is a diagram illustrating one example method comprising features as described herein;

FIG. 6 is a diagram illustrating one example method comprising features as described herein;

FIG. 7 is a diagram illustrating one example method comprising features as described herein;

FIG. 8 is a diagram illustrating one example method comprising features as described herein; and

FIG. 9 is a diagram illustrating one example method comprising features as described herein.

### DETAILED DESCRIPTION OF EXAMPLE EMBODIMENTS

The following abbreviations that may be found in the specification and/or the drawing figures are defined as follows:
3GPP third generation partnership project
5G fifth generation
5GC 5G core network
AMF access and mobility management function
BSR Buffer Status Report
CG-SDT Configured Grant based small data transmission (PUSCH transmission)
CU central unit
DL downlink
DU distributed unit
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
gNB (or gNodeB) base station for 5G/NR, i.e., a node providing NR user plane and control plane protocol terminations towards the UE, and connected via the NG interface to the 5GC
I/F interface
LTE long term evolution
MAC medium access control
MME mobility management entity
ng or NG new generation
ng-eNB or NG-eNB new generation eNB
NR new radio
NAY or NW network
PDCP packet data convergence protocol
PHR Power Headroom Report
PHY physical layer
PUSCH Physical Uplink Shared Channel
RA-SDT radio access based small data transmission
RACH Random Access Channel
RAN radio access network
Rel release
REL17 Release 17
RLC radio link control
RRH remote radio head
RRC radio resource control
RU radio unit
Rx receiver
SDAP service data adaptation protocol
SDT Small Data Transmission
SGW serving gateway
SMF session management function
TA timing advance
TS technical specification
Tx transmitter
UE user equipment (e.g., a wireless, typically mobile device)
UL Uplink
UPF user plane function

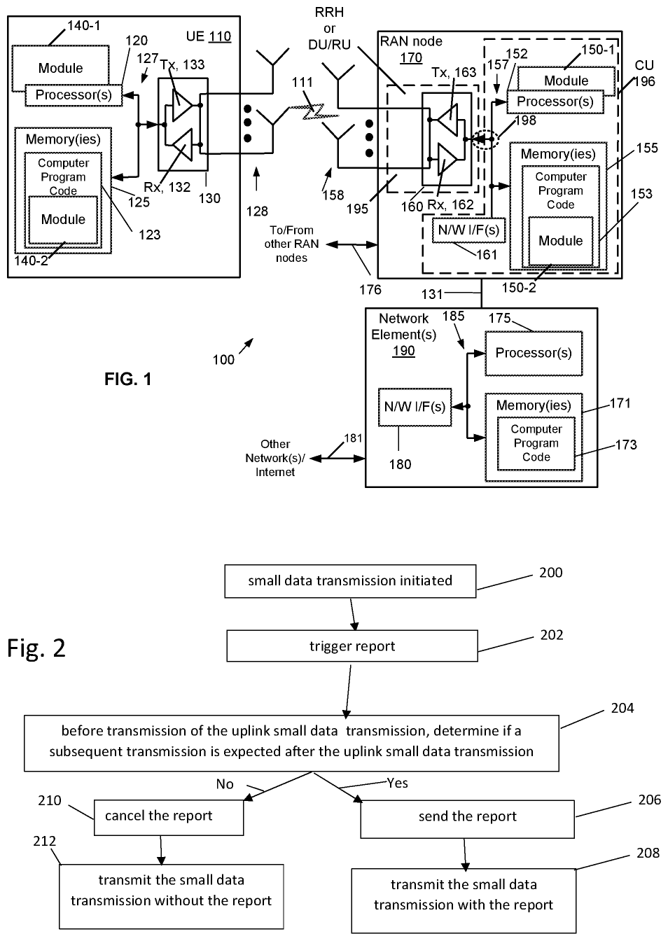

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(S)) and/or user plane functions (UPF(s)) and/or session management function(s) (SMF(s)). Such core network functionality for LTE may include MME (Mobility Management Entit Y)/SGW (Serving Gateway) functionality. These are merely exemplary functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Features as described herein may be used in relation to the new REL17 work item on NR small data transmissions in the RRC INACTIVE state for 5G NR described in RP-210870.

According to the objectives of the work item, three SDT types are being defined in REL17:
4-step RACH based SDT (4-step RA SDT): The Msg3 (PUSCH) is used by the UE to transmit the SDT payload;
2-step RACH based SDT (2-step RA SDT): The MsgA PUSCH is used by the UE to transmit the SDT payload;
Configured Grant based PUSCH transmission (CG-SDT): A Configured Grant type 1 based PUSCH resource can be used by the UE to transmit the SDT payload if UE has a valid timing advance (TA), i.e. without a random access procedure.

RAN2 has also agreed to support also the so-called multi-shot SDT procedures, including multiple subsequent UL/DL data transmission after the initial SDT transmission, where the subsequent transmissions are scheduled via e.g. dynamic grants:

RAN2 Agreements:
UL/DL transmission following UL SDT without transitioning to RRC_CONNECTED is supported
When UE is in RRC_INACTIVE, it should be possible to send multiple UL and DL packets as part of the same SDT mechanism and without transitioning to RRC_CONNECTED on dedicated grant. FFS on details and whether any indication to network is needed.

As noted in the “Justification” in RP-210870:

NR supports RRC_INACTIVE state and UEs with infrequent (periodic and/or non-periodic) data transmission are generally maintained by the network in the RRC_INACTIVE state. Until Rel-16, the RRC_INACTIVE state doesn't support data transmission. Hence, the UE has to resume the connection (i.e. move to RRC_CONNECTED state) for any DL (MT) and UL (MO) data. Connection setup and subsequently release to INACTIVE state happens for each data transmission however small and infrequent the data packets are. This results in unnecessary power consumption and signaling overhead.

Specific examples of small and infrequent data traffic include the following use cases:
Smartphone applications:
   Traffic from Instant Messaging services (whatsapp, QQ, wechat etc)
   Heart-beat/keep-alive traffic from IM/email clients and other apps
   Push notifications from various applications
Non-smartphone applications:
   Traffic from wearables (periodic positioning information etc)
   sensors (Industrial Wireless Sensor Networks transmitting temperature, pressure readings periodically or in an event triggered manner etc)
   smart meters and smart meter networks sending periodic meter readings

As noted in 3GPP TS 22.891, the NR system shall:
be efficient and flexible for low throughput short data bursts
support efficient signaling mechanisms (e.g. signaling is less than payload)
reduce signaling overhead in general

Signaling overhead from INACTIVE state UEs for small data packets is a general problem and will become a critical issue with more UEs in NR not only for network performance and efficiency but also for the UE battery performance. In general, any device that has intermittent small data packets in INACTIVE state will benefit from enabling small data transmission in INACTIVE.

The key enablers for small data transmission in NR, namely the INACTIVE state, 2-step, 4-step RACH and configured grant type-1 have already been specified as part of Rel-15 and Rel-16. So, this work builds on these building blocks to enable small data transmission in INACTIVE state for NR.

Also, as noted in the “Objective” in RP-210870:

This work item enables small data transmission in RRC_INACTIVE state as follows:
For the RRC_INACTIVE state:
   UL small data transmissions for RACH-based schemes (i.e. 2-step and 4-step RACH):
      General procedure to enable transmission of small data packets from INACTIVE state (e.g. using MSGA or MSG3) [RAN2]
      Enable flexible payload sizes larger than the Rel-16 CCCH message size that is possible currently for INACTIVE state for MSGA and MSG3 to support UP data transmission in UL (actual payload size can be up to network configuration) [RAN2]
      Context fetch and data forwarding (with and without anchor relocation) in INACTIVE state for RACH-based solutions [RAN2, RAN3]
      Note 1: The security aspects of the above solutions should be checked with SA3
   Transmission of UL data on pre-configured PUSCH resources (i.e. reusing the configured grant type 1)—when TA is valid
      General procedure for small data transmission over configured grant type 1 resources from INACTIVE state [RAN2]
      Configuration of the configured grant type1 resources for small data transmission in UL for INACTIVE state [RAN2]
   Specify RRM core requirements for small data transmission in RRC_INACTIVE, if needed [RAN4]
   No new RRC state should be introduced in this WID. Transmission of smalldata in UL, subsequent transmission of smalldata in UL and DL and the state transition decisions should be under network control.
   Focus of the WID should be on licensed carriers and the solutions can be reused for NR-U if applicable.
   Specify configuring of SRB1 and SRB2 for small data transmission in RRC_INACTIVE state by reusing the framework for DRBs.
   Note 2: Any associated specification work in RAN1 that is needed to support the above set of objectives should be initiated by RAN2 via an LS.

In addition, The following was agreed in the previous RAN2 meeting:
5 PHR functionality is supported for SDT. FFS on PHR procedure

Currently, the following is specified for BSR reporting (TS 38.321):
All triggered BSRs may be cancelled when the UL grant(s) can accommodate all pending data available for transmission but is not sufficient to additionally accommodate the BSR MAC CE plus its subheader.

The UE can be configured to provide regular power headroom reports (PHRs) on its power usage to assist the scheduler in the selection of a combination of modulation and coding scheme (MCS) and physical radio resource size to ensure such combination does not lead to the UE being power limited. The PHR triggers are currently defined as follows (TS 38.321):
A Power Headroom Report (PHR) shall be triggered if any of the following events occur:
   phr-ProhibitTimer expires or has expired and the path loss has changed more than phr-Tx-PowerFactorChange dB for at least one activated Serving Cell of any MAC entity of which the active DL BWP is not dormant BWP which is used as a pathloss reference since the last transmission of a PHR in this MAC entity when the MAC entity has UL resources for new transmission;
   NOTE 1: The path loss variation for one cell assessed above is between the pathloss measured at present time on the current pathloss reference and the pathloss measured at the transmission time of the last transmission of PHR on the pathloss reference in use at that time, irrespective of whether the pathloss reference has changed in between. The current pathloss reference for this purpose does not include any pathloss reference configured using pathlossReferenceRS-Pos in TS 38.331 [5].
   phr-PeriodicTimer expires;
   upon configuration or reconfiguration of the power headroom reporting functionality by upper layers, which is not used to disable the function;
   activation of an SCell of any MAC entity with configured uplink of which firstActiveDownlinkBWP-Id is not set to dormant BWP;
   addition of the PSCell (i.e. PSCell is newly added or changed);
   phr-ProhibitTimer expires or has expired, when the MAC entity has UL resources for new transmission, and the following is true for any of the activated Serving Cells of any MAC entity with configured uplink:
   there are UL resources allocated for transmission or there is a PUCCH transmission on this cell, and the required power backoff due to power management (as allowed by P-MPR, as specified in TS 38.101-1 [14], TS 38.101-2 [15], and TS 38.101-3 [16]) for this cell has changed more than phr-Tx-PowerFactorChange dB since the last transmission of a PHR when the MAC entity had UL resources allocated for transmission or PUCCH transmission on this cell.
   Upon switching of activated BWP from dormant BWP to non-dormant DL BWP of an SCell of any MAC entity with configured uplink;
   if mpe-Reporting-FR2 is configured, and mpe-ProhibitTimer is not running:
   the measured P-MPR applied to meet FR2 MPE requirements as specified in TS 38.101-2 is equal to or larger than mpe-Threshold for at least one activated FR2 Serving Cell since the last transmission of a PHR in this MAC entity; or
   the measured P-MPR applied to meet FR2 MPE requirements as specified in TS 38.101-2 has changed more than phr-Tx-PowerFactorChange dB for at least one activated FR2 Serving Cell since the last transmission of a PHR due to the measured P-MPR applied to meet MPE requirements being equal to or larger than mpe-Threshold in this MAC entity.
   in which case the PHR is referred below to as ‘MPE P-MPR report’.
   NOTE 2: The MAC entity should avoid triggering a PHR when the required power backoff due to power management decreases only temporarily (e.g. for up to a few tens of milliseconds) and it should avoid reflecting such temporary decrease in the values of P_{CMAX,f,c}/PH when a PHR is triggered by other triggering conditions.
   NOTE 3: If a HARQ process is configured with cg-RetransmissionTimer and if the PHR is already included in a MAC PDU for transmission by this HARQ process, but not yet transmitted by lower layers, it is up to UE implementation how to handle the PHR content.

Besides, Data Volume and Power Headroom Reporting in NB-IoT is defined in 3GPP TS 36.321:
The Data Volume and Power Headroom reporting procedure is only applicable for NB-IoT UEs and is used to provide the serving eNB with information about the amount of data available for transmission in the UL buffers associated with the MAC entity, and to provide the serving eNB with information about the difference between the nominal UE maximum transmission power and the estimated transmission power for UL-SCH transmission for the Serving Cell. The reporting is done using the DPR MAC control element, which is sent in Msg3 together with a CCCH SDU. For EDT, the Data Volume in DPR MAC control element is set to zero.
If enhancedPHR is configured and the UE supports extended power headroom reporting, the UE shall:
   if the UE supports power class 14 dBm and the MAC entity considers itself to be in enhanced coverage level other than 0:
      report power headroom level using the DPR MAC control element;
   else:
      report extended power headroom level using the DPR MAC control element for Extended Power Headroom level reporting.

With the current PHR procedure, the UE would report PHR always in the first SDT transmission based on the following condition (see PHR triggers in Section 2):
“upon configuration or reconfiguration of the power headroom reporting functionality by upper layers, which is not used to disable the function;”
   given that the default MAC configuration is applied for the initial SDT transmission.

However, the reporting of the PHR in the initial SDT transmission seems to be only meaningful if the initial SDT transmission follows with at least one subsequent SDT transmission in the UL, in which case the network (NW) can take the PHR received from the UE into account for its subsequent scheduling decisions. Furthermore, even though the UE buffer would become empty after the initial SDT transmission, it would not necessarily mean there would not be subsequent UL transmission(s), e.g., after DL response messages (cf. TCP SYN, SYN-ACK, ACK procedure).

With features as described herein, the UE may determine whether to trigger or transmit PHR upon initiation of SDT procedure based on one or more conditions.

In one example embodiment, the UE may cancel a triggered PHR (or does not trigger a PHR) upon SDT initiation when the UE does not expect any subsequent transmission after the initial UL SDT transmission such as, for example, when the initial SDT transmission includes all the data in the UE buffer and UE does not expect further data to appear in the buffer during the SDT procedure. The lack of PHR in the first SDT transmission may also serve as an indication to network that no further data is expected.

Referring to FIG. 2, an example is illustrated. In this example the a SDT has been initiated with the UE as indicated by block 200 and generates the report as indicated by block 202. The UE then determines if a subsequent transmission after the initial UL SDT transmission is expected as indicated by block 204. If the UE determines that subsequent transmission after the initial UL SDT transmission is expected, then the UE can determine to send the report as indicated by block 206 and transmit the SDT with the report as indicated by block 208. If the UE determines that subsequent transmission after the initial UL SDT transmission is not expected, then the UE can determine to cancel the report as indicated by block 210 and transmit the SDT without the report as indicated by block 212.

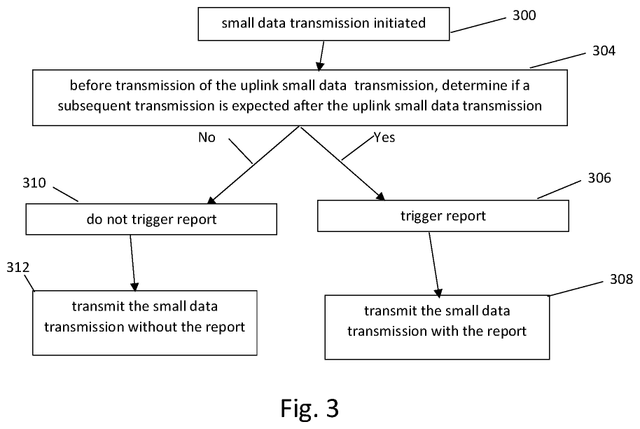

Referring also to FIG. 3, another example is illustrated. In this example the SDT has been initiated with the UE as indicated by block 300. The UE then determines if a subsequent transmission after the initial UL SDT transmission is expected as indicated by block 304. If the UE determines that subsequent transmission after the initial UL SDT transmission is expected, then the UE can determine to trigger the report as indicated by block 306 and transmit the SDT with the report as indicated by block 308. If the UE determines that subsequent transmission after the initial UL SDT transmission is not expected, then the UE can determine to not trigger the report as indicated by block 310 and transmit the SDT without the report as indicated by block 312.

In another example embodiment, the UE may include a report, such as either BSR or PHR, in the first UL SDT transmission to indicate the presence of subsequent data to transmit. For example, a BSR may be initially transmitted with the first UL SDT transmission to indicate the presence of a PHR to be subsequently transmitted. The UE may cancel the other reporting when both BRS and PHR are triggered. In one example embodiment, the order of UE cancelling a triggered BSR and/or PHR for the initial SDT transmission can depend on whether the UE expects subsequent transmissions to happen or not. In one example embodiment, the UE may cancel the triggered BSR (or does not trigger a BSR) upon SDT initiation before cancelling the triggered PHR; when the UE expects subsequent transmissions after the initial SDT transmission, but the initial transmission can accommodate all the data in the UE buffer. In one example embodiment, if the UE does not expect subsequent transmissions after the initial SDT transmission, the UE may cancel PHR and, after that, check the legacy condition whether the BSR is cancelled such as, for example, whether the initial transmission can accommodate all the data in the UE buffer but not the BSR report plus its subheader. The BSR may be cancelled and then the UE may check if the PHR should also be cancelled such as, for example, if the PHR does not fit to the grant and no subsequent transmission is expected. However, it does not necessarily cancel the PHR, for example, when the UE expects a subsequent transmission(s).

In one example embodiment, the UE does not trigger PHR for SDT when only a single-shot SDT is allowed in the cell, or when only a single-shot SDT is supported by the UE. The indication of the allowance of a single-shot only (or disallowance of multi-shot) by a cell may be, for instance, provisioned via SIB signaling.

In one example embodiment, the UE does not trigger PHR for SDT when the available power headroom for its serving cell is above a threshold. The threshold may be configured by the network or its value could be fixed such as, for example, pre-provisioned to the UE in a standard specification.

In one example embodiment, the UE may be configured to not cancel the PHR for SDT when the UE applies power backoff to meet MPE requirements such as specified in TS 38.101-2 for example.

The UE behavior in terms of PHR triggering/reporting for SDT may also be configurable by the network. For example, the network might configure the UE for PHR triggering/reporting with SDT through system information block (SIB) or dedicated RRC signaling, such as a RRCRelease message for example. The configuration could be explicitly enabled, disabled, or enabled only for certain conditions. The configuration may also be separately configured for RA-SDT and CG-SDT.

With features as described herein, the PHR information may be reported only when it is beneficial at the network side for its scheduling decision, and may be omitted otherwise such as, for example, when it would be unnecessary.

With features as described herein, absence of PHR can serve as an implicit indication to network that no subsequent data is expected by the UE.

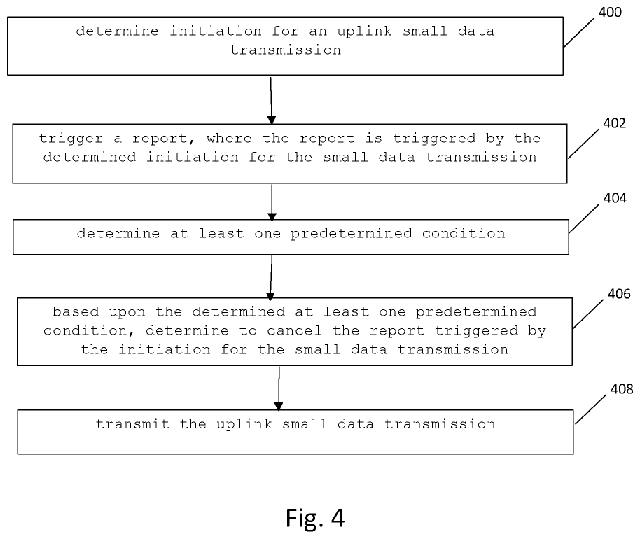

Referring also to FIG. 4, an example method may be provided comprising: determining initiation for an uplink small data transmission for the apparatus as illustrated with block 400; triggering a report as illustrated with block 402, where the report is triggered by or triggered based on the determined initiation for the small data transmission; determining at least one predetermined condition as illustrated with block 404; based upon the determined at least one predetermined condition, determining to cancel the report triggered by or triggered based on the initiation for the small data transmission as illustrated with block 406; and transmitting the uplink small data transmission as illustrated with block 408.

An example embodiment may be provided in an apparatus comprising: at least one processor; and at least one non-transitory memory including computer program code such as 125 shown in FIG. 1 for example, the at least one memory and the computer program code configured to, with the at least one processor, cause the apparatus to: determine initiation for an uplink small data transmission for the apparatus; trigger a report, where the report is triggered by or triggered based on the determined initiation for the small data transmission; determine at least one predetermined condition; based upon the at least one predetermined condition, determine to cancel the report triggered by or triggered based on the initiation for the small data transmission; and transmit or cause transmitting of the uplink small data transmission.

The determining of the at least one predetermined condition may comprise determining that at least one condition or event has occurred or is present. The report may comprise a power headroom report. The at least one predetermined condition may comprise the apparatus not expecting a subsequent transmission after the uplink small data transmission. The uplink small data transmission may comprise data in a buffer of the apparatus and the apparatus does not expect further data to appear in the buffer during the uplink small data transmission. A lack of the report in the uplink small data transmission may be configured to indicate to network equipment that no further data is expected after the uplink small data transmission. The apparatus may be configured to determine that a subsequent transmission after the uplink small data transmission is expected. The apparatus may be configured to trigger the report based, at least partially, upon the determination that the subsequent transmission after the uplink small data transmission is expected. The at least one memory and the computer program code may be configured to, with the at least one processor, cause the apparatus to transmit the report based, at least partially, upon the determination that the subsequent transmission after the uplink small data transmission is expected. The at least one predetermined condition may comprise both the report and another report are triggered and the another report being sent with the uplink small data transmission, where: the report comprises a power headroom report and the another report comprises a buffer status report, or the report comprises the buffer status report and the another report comprises the power headroom report.

The at least one memory and the computer program code may be configured to, with the at least one processor, cause the apparatus to cancel the report relative to the another report for the uplink small data transmission based upon whether a subsequent is expected by the apparatus. The “relative to” may comprise canceling the report while keeping the another report to be transmitted with the small data transmission. The report may comprise a buffer status report. The at least one memory and the computer program code may be configured to, with the at least one processor, cause the apparatus to determine whether to cancel another report based upon the at least one predetermined condition. The at least one memory and the computer program code may be configured to, with the at least one processor, cause the apparatus to cancel the report when the apparatus has determined that a subsequent transmission is not expected after the uplink small data transmission and after the apparatus determined that a buffer status report has been cancelled. The another report may comprise a power headroom report. The at least one predetermined condition may comprise a subsequent transmission being expected after the uplink small data transmission and the uplink small data transmission accommodating all data in a buffer of the apparatus. The at least one predetermined condition may comprise a condition where a single-shot uplink small data transmission is allowed. The at least one memory and the computer program code may be configured to, with the at least one processor, cause the apparatus to receive an indication regarding the condition where a single-shot uplink small data transmission is allowed by a system information block signaling. The indication may be configured to indication one of: that a single-shot uplink small data transmission is allowed, or that a multi-shot uplink small data transmission is not allowed. The at least one predetermined condition may comprise a condition where a single-shot uplink small data transmission is supported by the apparatus. The at least one predetermined condition may comprise when an available power headroom for a serving cell is above a threshold. The threshold may be one of: configured by a network entity, and the apparatus is configured to receive a signal comprising a value of the threshold, or comprises a fixed value. The at least one memory and the computer program code may be configured to, with the at least one processor, cause the apparatus to prevent cancelling of the report when the apparatus applies a power backoff to meet maximum permissible exposure. The at least one memory and the computer program code may be configured to, with the at least one processor, cause the apparatus to cancel the report based upon the determination to cancel the report. The at least one memory and the computer program code may be configured to, with the at least one processor, cause the apparatus to receive instructions from a network entity to be used to at least partially determine the at least one predetermined condition. The at least one memory and the computer program code may be configured to, with the at least one processor, cause the apparatus to receive the instructions through at least one of a system information block signaling or a dedicated radio resource control signaling. The dedicated radio resource control signaling may comprise a RRCRelease message. The at least one memory and the computer program code may be configured to, with the at least one processor, cause the apparatus to determine to cancel the report based upon at least one of: an explicit enablement, a disablement, or an enabled only for certain conditions. The at least one memory and the computer program code may be configured to, with the at least one processor, cause the apparatus to determine to cancel the report based upon the uplink small data transmission being one of: a random access based small data transmission, or a configured grant based small data transmission. The at least one memory and the computer program code may be configured to, with the at least one processor, cause the apparatus to, based upon the at least one predetermined condition, prevent triggering of the report to accompany the small data transmission.

An example embodiment may be provided with an apparatus comprising means for performing: determining initiation for an uplink small data transmission for the apparatus; triggering a report, where the report is triggered by the determined initiation for the small data transmission; determining at least one predetermined condition; based upon the determined at least one predetermined condition, determining to cancel the report triggered by the initiation for the small data transmission; and transmitting the uplink small data transmission.

An example embodiment may be provided with an apparatus comprising processing circuitry; and memory circuitry including computer program code, where the memory circuitry and the computer program code configured to, with the processing circuitry, cause the apparatus to: determine initiation for an uplink small data transmission for the apparatus; trigger a report, where the report is triggered by the determined initiation for the small data transmission; determine at least one predetermined condition; based upon the at least one predetermined condition, determine to cancel the report triggered by the initiation for the small data transmission; and transmit or cause transmitting of the uplink small data transmission.

An example embodiment may be provide with an apparatus comprising a non-transitory program storage device readable by a machine such as 125 shown in FIG. 1 for example, tangibly embodying a program of instructions executable by the machine for performing operations, the operations comprising: determining initiation for an uplink small data transmission for the apparatus; triggering a report, where the report is triggered by the determined initiation for the small data transmission; determining at least one predetermined condition; based upon the determined at least one predetermined condition, determining to cancel the report triggered by the initiation for the small data transmission; and causing transmitting of the uplink small data transmission.

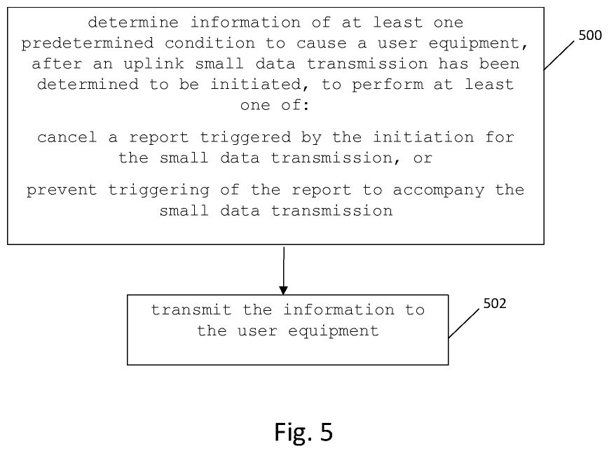

Referring also to FIG. 5, an example method may be provided comprising: as illustrated with block 500, determining information of at least one predetermined condition to cause a user equipment, after an uplink small data transmission has been determined to be initiated, to perform at least one of: cancelling a report triggered by the initiation for the small data transmission, or preventing triggering of the report to accompany the small data transmission; and transmit the information to the user equipment as illustrated with block 502.

An example embodiment, such as at a network equipment or network entity for example, may be provided with an apparatus comprising: at least one processor; and at least one non-transitory memory including computer program code such as 155 shown in FIG. 1 for example, the at least one memory and the computer program code configured to, with the at least one processor, cause the apparatus to: determine information of at least one predetermined condition to cause a user equipment, after an uplink small data transmission has been determined to be initiated, to perform at least one of: cancel a report triggered by the initiation for the small data transmission, or prevent triggering of the report to accompany the small data transmission; and transmit or cause transmitting of the information to the user equipment.

The report may comprise a power headroom report. The at least one predetermined condition may comprise the user equipment not expecting a subsequent transmission after the uplink small data transmission. The at least one predetermined condition may comprise the user equipment expecting a subsequent transmission after the uplink small data transmission. The at least one predetermined condition may comprise both the report and another report being triggered, and the another report being sent with the uplink small data transmission, where: the report comprises a power headroom report and the another report comprises a buffer status report, or the report comprises the buffer status report and the another report comprises the power headroom report. The at least one predetermined condition may comprise a condition where a single-shot uplink small data transmission is allowed. The at least one predetermined condition may comprise a condition where a single-shot uplink small data transmission is supported by the user equipment. The at least one predetermined condition may comprise when an available power headroom for a serving cell is above a threshold. The information may be configured to prevent the user equipment from cancelling of the report when the user equipment applies a power backoff to meet maximum permissible exposure. The report may comprise a buffer status report. The at least one predetermined condition may comprise the user equipment expecting subsequent transmissions after the uplink small data transmission and the uplink small data transmission can accommodate all data in an apparatus buffer, where the apparatus is configured to configured the user equipment to cancel the buffer status report or prevent triggering of the buffer status report before cancelling a triggered power headroom report.

An example embodiment may be provided with an apparatus comprising means for performing: determining information of at least one predetermined condition to cause a user equipment, after an uplink small data transmission has been determined to be initiated, to perform at least one of: cancelling a report triggered by the initiation for the small data transmission, or preventing triggering of the report to accompany the small data transmission; and transmitting the information to the user equipment.

An example embodiment may be provided with an apparatus comprising processing circuitry; and memory circuitry including computer program code, where the memory circuitry and the computer program code configured to, with the processing circuitry, cause the apparatus to: determine information of at least one predetermined condition to cause a user equipment, after an uplink small data transmission has been determined to be initiated, to perform at least one of: cancel a report triggered by the initiation for the small data transmission, or prevent triggering of the report to accompany the small data transmission; and cause transmitting of the information to the user equipment.

An example embodiment may be provided with an apparatus comprising a non-transitory program storage such as 155 shown in FIG. 1 for example device readable by a machine, tangibly embodying a program of instructions executable by the machine for performing operations, the operations comprising: determining information of at least one predetermined condition to cause a user equipment, after an uplink small data transmission has been determined to be initiated, to perform at least one of: cancelling a report triggered by the initiation for the small data transmission, or preventing triggering of the report to accompany the small data transmission; and transmitting or causing transmitting of the information to the user equipment.

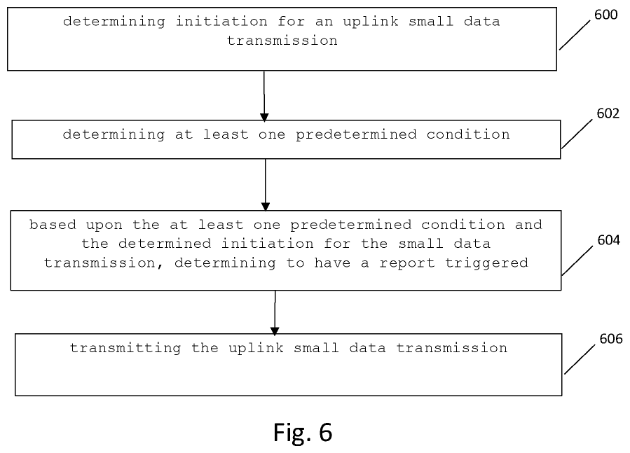

Referring also to FIG. 6, an example method may be provided comprising: determining initiation for an uplink small data transmission for the apparatus as illustrated with block 600; determining at least one predetermined condition as illustrated with block 602; based upon the at least one predetermined condition and the determined initiation for the small data transmission, determining to have a report triggered as illustrated with block 604; and transmitting the uplink small data transmission as illustrated with block 606.

An example embodiment may be provided with an apparatus comprising: at least one processor; and at least one non-transitory memory including computer program code such as 125 shown in FIG. 1 for example, the at least one memory and the computer program code configured to, with the at least one processor, cause the apparatus to: determine initiation for an uplink small data transmission for the apparatus; determine at least one predetermined condition; based upon the at least one predetermined condition and the determined initiation for the small data transmission, determine to have a report triggered; and transmit or cause transmitting of the uplink small data transmission. The at least one condition may be a status, a state, an event, an occurrence, a situation, a circumstance, a requirement or an occasion for example. For example, the triggering of the report may be configured to occur based upon the at least one predetermined condition or an event, or occurrence of the condition/event. If the at least one predetermined condition or event or occurrence of the condition/event does not occur, the apparatus may be configured such that the report would not be triggered. In various example embodiments, the determining to have the report triggered may allow the report to be triggered, or prevent the report from being triggered, or abstain from triggering the report, or abstain from transmitting the report with the small data transmission, or otherwise omit the report from being triggered or transmitted.

The report may comprise a power headroom report. The report may comprise a buffer status report. The at least one memory and the computer program code may be configured to, with the at least one processor, cause the apparatus to transmit the uplink small data transmission with or without the report based upon the determination to have the report triggered. The at least one predetermined condition may comprise the apparatus not expecting a subsequent transmission after the uplink small data transmission. The at least one memory and the computer program code may be configured to, with the at least one processor, cause the apparatus to determine that a subsequent transmission after the uplink small data transmission is expected. The at least one memory and the computer program code may be configured to, with the at least one processor, cause the apparatus to trigger the report based, at least partially, upon the determination that the subsequent transmission after the uplink small data transmission is expected. The at least one memory and the computer program code may be configured to, with the at least one processor, cause the apparatus to transmit the report based, at least partially, upon the determination that the subsequent transmission after the uplink small data transmission is expected. The at least one predetermined condition may comprise both the report and another report are triggered and the another report being sent with the uplink small data transmission, where: the report comprises a power headroom report and the another report comprises a buffer status report, or the report comprises the buffer status report and the another report comprises the power headroom report. The at least one memory and the computer program code may be configured to, with the at least one processor, cause the apparatus to determine whether to cancel another report based upon the at least one predetermined condition or at least one other predetermined condition. The another report may comprise a power headroom report. The at least one predetermined condition may comprise a subsequent transmission being expected after the uplink small data transmission and the uplink small data transmission accommodating all data in a buffer of the apparatus. The at least one predetermined condition may comprise a condition where a single-shot uplink small data transmission is allowed. The at least one predetermined condition may comprise a condition where a single-shot uplink small data transmission is supported by the apparatus. The at least one predetermined condition may comprise when an available power headroom for a serving cell is above a threshold. The at least one memory and the computer program code may be configured to, with the at least one processor, cause the apparatus to prevent cancelling of the report when the apparatus applies a power backoff to meet maximum permissible exposure. The at least one memory and the computer program code may be configured to, with the at least one processor, cause the apparatus to cancel the report based upon a determination to cancel the report. The at least one memory and the computer program code may be configured to, with the at least one processor, cause the apparatus to determine to cancel the report based upon the at least one predetermined condition and/or based upon at least one other predetermined condition. The at least one memory and the computer program code may be configured to, with the at least one processor, cause the apparatus to receive instructions from a network entity to at least partially configured the apparatus to determine the at least one predetermined condition.

An example embodiment may be provided with an apparatus comprising means for performing: determining initiation for an uplink small data transmission for the apparatus; determining at least one predetermined condition; based upon the at least one predetermined condition and the determined initiation for the small data transmission, determining to have a report triggered; and transmitting the uplink small data transmission.

An example embodiment may be provided with an apparatus comprising a non-transitory program storage device, such as 125 shown in FIG. 1 for example, readable by a machine, tangibly embodying a program of instructions executable by the machine for performing operations, the operations comprising: determining initiation for an uplink small data transmission for the apparatus; determining at least one predetermined condition; based upon the at least one predetermined condition and the determined initiation for the small data transmission, determining to have a report triggered; and transmitting or causing transmitting of the uplink small data transmission.

An example embodiment may be provided with an apparatus comprising processing circuitry; and memory circuitry including computer program code, where the memory circuitry and the computer program code configured to, with the processing circuitry, cause the apparatus to: determine initiation for an uplink small data transmission for the apparatus; determine at least one predetermined condition; based upon the at least one predetermined condition and the determined initiation for the small data transmission, determine to have a report triggered; and transmit or cause transmitting of the uplink small data transmission.

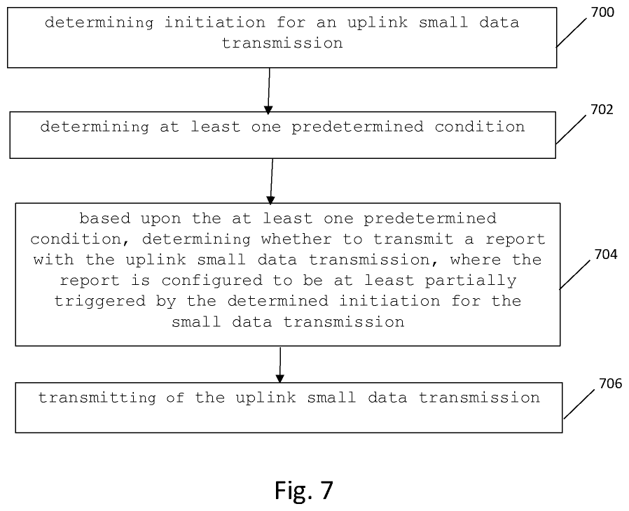

Referring also to FIG. 7, an example method may be provided comprising: determining initiation for an uplink small data transmission for the apparatus as illustrated with block 700; determining at least one predetermined condition as illustrated with block 702; based upon the at least one predetermined condition, determining whether to transmit a report with the uplink small data transmission, where the report is configured to be at least partially triggered by the determined initiation for the small data transmission as illustrated with block 704; and transmitting of the uplink small data transmission as illustrated with block 706.

An example embodiment may be provided with an apparatus comprising: at least one processor; and at least one non-transitory memory including computer program code such as 125 shown in FIG. 1 for example, the at least one memory and the computer program code configured to, with the at least one processor, cause the apparatus to: determine initiation for an uplink small data transmission for the apparatus; determine at least one predetermined condition; based upon the at least one predetermined condition, determine whether to transmit a report with the uplink small data transmission, where the report is configured to be at least partially triggered by the determined initiation for the small data transmission; and transmit or cause transmitting of the uplink small data transmission.

An example embodiment may be provided with an apparatus comprising means for performing: determining initiation for an uplink small data transmission for the apparatus; determining at least one predetermined condition; based upon the at least one predetermined condition, determining whether to transmit a report with the uplink small data transmission, where the report is configured to be at least partially triggered by the determined initiation for the small data transmission; and transmitting or causing transmitting the uplink small data transmission.

An example embodiment may be provided with an apparatus comprising a non-transitory program storage device, such as 125 shown in FIG. 1 for example, readable by a machine, tangibly embodying a program of instructions executable by the machine for performing operations, the operations comprising: determining initiation for an uplink small data transmission for the apparatus; determining at least one predetermined condition; based upon the at least one predetermined condition, determining whether to transmit a report with the uplink small data transmission, where the report is configured to be at least partially triggered by the determined initiation for the small data transmission; and transmitting or causing transmitting of the uplink small data transmission.

An example embodiment may be provided with an apparatus comprising processing circuitry; and memory circuitry including computer program code, where the memory circuitry and the computer program code configured to, with the processing circuitry, cause the apparatus to: determine initiation for an uplink small data transmission for the apparatus; determine at least one predetermined condition; based upon the at least one predetermined condition, determine whether to transmit a report with the uplink small data transmission, where the report is configured to be at least partially triggered by the determined initiation for the small data transmission; and transmit or cause transmitting of the uplink small data transmission.

The determination of whether to transmit the report with the uplink small data transmission comprises one of: determining to cancel the report, or determining to not trigger the report.

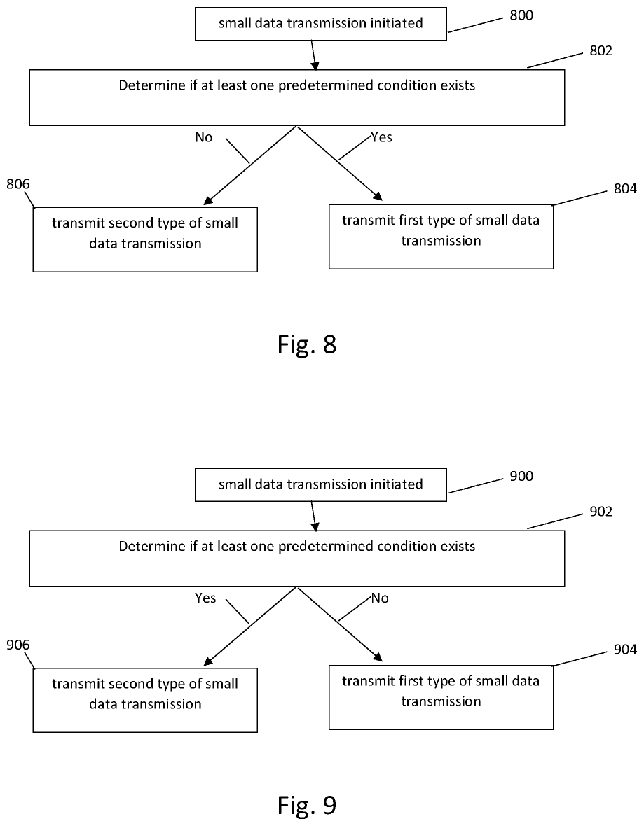

Referring also to FIG. 8, in one example method after a small data transmission has been initiated as illustrated by block 800, the UE may determine if at least one predetermined condition exists as illustrated by block 802. Then, based upon the determination of whether or not the at least one predetermined condition exists, the UE may then transmit a first type of small data transmission if the predetermined condition is present as illustrated by block 804, such as with a PHR report for example, or transmit a second type of small data transmission if the predetermined condition is not present as illustrated by block 806, such as without a PHR report for example. In one type of example, the two small data transmission may be identical except for the inclusion or absence of the report.

Referring also to FIG. 9, in one example method after a small data transmission has been initiated as illustrated by block 900, the UE may determine if at least one predetermined condition exists as illustrated by block 902. Then, based upon the determination of whether or not the at least one predetermined condition exists, the UE may then transmit a first type of small data transmission if the predetermined condition is not present as illustrated by block 904, such as with a PHR report for example, or transmit a second type of small data transmission if the predetermined condition is present as illustrated by block 906, such as without a PHR report for example. In one type of example, the two small data transmission may be identical except for the inclusion or absence of the report.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

1-50. (canceled)

51. An apparatus comprising:
at least one processor; and
at least one non-transitory memory including computer program code, the at least one memory and the computer program code configured to, with the at least one processor, cause the apparatus to:
determine initiation for an uplink small data transmission for the apparatus;
trigger a report, where the report is triggered by the determined initiation for the small data transmission;
determine at least one predetermined condition;
based upon the at least one predetermined condition, determine to cancel the report triggered by the initiation for the small data transmission; and
transmit the uplink small data transmission.

52. The apparatus as claimed in claim 51, where the report comprises a power headroom report.

53. The apparatus as claimed in claim 51, where the at least one predetermined condition comprises the apparatus not expecting a subsequent transmission after the uplink small data transmission.

54. The apparatus as claimed in claim 51, where the apparatus is configured to determine that a subsequent transmission after the uplink small data transmission is expected.

55. The apparatus as claimed in claim 51, where the at least one predetermined condition comprises both the report and another report are triggered and the another report being sent with the uplink small data transmission, where:
the report comprises a power headroom report and the another report comprises a buffer status report, or
the report comprises the buffer status report and the another report comprises the power headroom report.

56. The apparatus as claimed in claim 55, where the at least one memory and the computer program code are configured to, with the at least one processor, cause the apparatus to cancel the report relative to the another report for the uplink small data transmission based upon whether a subsequent transmission is expected by the apparatus.

57. The apparatus as claimed in claim 51, where the report comprises a buffer status report.

58. The apparatus as claimed in claim 57, where the at least one memory and the computer program code are configured to, with the at least one processor, cause the apparatus to determine whether to cancel another report based upon the at least one predetermined condition.

59. The apparatus as claimed in claim 58, where the at least one memory and the computer program code are configured to, with the at least one processor, cause the apparatus to cancel the report when the apparatus has determined that a subsequent transmission is not expected after the uplink small data transmission and after the apparatus determined that a buffer status report has been cancelled.

60. The apparatus as claimed in claim 58, where the another report comprises a power headroom report.

61. The apparatus as claimed in claim 51, where the at least one predetermined condition comprises a condition where a single-shot uplink small data transmission is allowed.

62. The apparatus as claimed in claim 61, where the at least one memory and the computer program code are configured to, with the at least one processor, cause the apparatus to receive an indication regarding the condition where a single-shot uplink small data transmission is allowed by a system information block signaling.

63. The apparatus as claimed in claim 51, where the at least one predetermined condition comprises a condition where a single-shot uplink small data transmission is supported by the apparatus.

64. The apparatus as claimed in claim 51, where the at least one predetermined condition comprises when an available power headroom for a serving cell is above a threshold.

65. The apparatus as claimed in claim 51, where the at least one memory and the computer program code are configured to, with the at least one processor, cause the apparatus to prevent cancelling of the report when the apparatus applies a power backoff to meet maximum permissible exposure.

66. The apparatus as claimed in claim 51, where the at least one memory and the computer program code are configured to, with the at least one processor, cause the apparatus to cancel the report based upon the determination to cancel the report.

67. The apparatus as claimed in claim 51, where the at least one memory and the computer program code are configured to, with the at least one processor, cause the apparatus to receive instructions from a network entity to be used to at least partially determine the at least one predetermined condition.

68. The apparatus as claimed in claim 67, where the at least one memory and the computer program code are configured to, with the at least one processor, cause the apparatus to receive the instructions through at least one of a system information block signaling or a dedicated radio resource control signaling.

69. A method comprising:
determining initiation for an uplink small data transmission for a user equipment;
triggering a report, where the report is triggered by the determined initiation for the small data transmission;
determining at least one predetermined condition;
based upon the determined at least one predetermined condition, determining to cancel the report triggered by the initiation for the small data transmission; and
transmitting the uplink small data transmission.

70. An apparatus comprising:
at least one processor; and
at least one non-transitory memory including computer program code, the at least one memory and the computer program code configured to, with the at least one processor, cause the apparatus to:
determine information of at least one predetermined condition to cause a user equipment, after an uplink small data transmission has been determined to be initiated, to perform at least one of:
cancel a report triggered by the initiation for the small data transmission, or
prevent triggering of the report to accompany the small data transmission; and
transmit the information to the user equipment.
